(19) United States
(12) Patent Application Publication
(10) Pub. No.: US 2024/0017567 A1
(43) Pub. Date: Jan. 18, 2024

(54) VEHICLE WHEEL AND VEHICLE

(71) Applicant: TOYOTA JIDOSHA KABUSHIKI KAISHA, Toyota-shi Aichi-ken (JP)

(72) Inventors: Tatsuhide HOSHI, Ichinomioya-shi Aichi-ken (JP); Yuta SAITO, Nisshin-shi Aichi-ken (JP)

(73) Assignee: TOYOTA JIDOSHA KABUSHIKI KAISHA, Toyota-shi Aichi-ken (JP)

(21) Appl. No.: 18/220,945

(22) Filed: Jul. 12, 2023

(30) Foreign Application Priority Data
Jul. 13, 2022 (JP) 2022-112112

(51) Int. Cl. B60B 1/04; B60B 3/04

(52) U.S. Cl. CPC B60B 1/04; B60B 3/04

(57) ABSTRACT

A vehicle wheel includes a rim having an outer periphery to which a tire is mounted and housing a braking device, a hub attached to an axle, and a plurality of spokes connecting the hub with the rim. Each spoke includes a protrusion protruding outward in a vehicle width direction from a design face of the vehicle wheel and extending along a direction in which the spoke extends.

### CROSS REFERENCE TO RELATED APPLICATION

This application claims priority to Japanese Patent Application No. 2022-112112 filed on Jul. 13, 2022, which is incorporated herein by reference in its entirety including the specification, claims, drawings, and abstract.

### TECHNICAL FIELD

The present disclosure relates to a configuration of a vehicle wheel, and to a configuration of a vehicle including a vehicle wheel.

### BACKGROUND

To enhance aerodynamic performance of a vehicle wheel, JP 2018-020591 A, for example, proposes a technique related to a configuration including a straightening or regulating vane on a front surface of a wheel to thereby prevent separation of an air flow flowing along a side face of a vehicle body from the front face of the wheel during traveling of the vehicle.

JP 6708624 B further proposes a configuration including an annular flow regulator at an end of the rim on the vehicle body side to thereby reduce air resistance and also direct the air for cooling a braking device into the interior of the wheel.

### SUMMARY

The techniques disclosed in JP 2018-020591 A and JP 6708624 B are not, however, able to sufficiently regulate the air flow flowing along the vehicle side face and increase the brake cooling performance.

An aspect of the present disclosure is therefore aimed toward providing a vehicle wheel that enables regulation of the air flow to increase the brake cooling performance.

In accordance with an aspect of the disclosure, a vehicle wheel includes a rim having a substantially cylindrical shape, which has an outer periphery to which a tire is mounted and houses a braking device; a hub attached to an axle; and a plurality of spokes extending from the hub toward the rim to connect the hub and the rim. Each of the spokes includes a protrusion protruding outward in a vehicle width direction from a design face of the vehicle wheel and extending along a direction in which the spoke extends.

This configuration allows the air flowing outward along the vehicle width from an interior of the rim to be separated from a leading edge of the protrusion to thereby generate a small vortex behind the protrusion toward the rear of the vehicle. This small vortex prevents separation of the side flow of the vehicle from a vehicle side face, reducing vortexes to be generated at the rear of the vehicle body and thereby increasing aerodynamic performance of the vehicle. The protrusion further prevents separation of the air flowing along the design face of the vehicle wheel from the design face. This enables generation of a smooth outward air flow along the vehicle width from the rim interior and increases the volume of cooling air for the braking device housed within the rim to thereby increase the brake cooling effect.

In the vehicle wheel of the disclosure, each spoke may be inclined rearward in a rotation direction of the vehicle wheel of a vehicle moving forward, from a radial direction of the vehicle wheel.

This configuration enables the air flow from the interior of the rim toward the outside along the vehicle width to be directed rearward of the vehicle and outward along the vehicle width, thereby guiding the air flow along the design face of the vehicle wheel. This prevents turbulence of the side flow flowing along the side face of the vehicle and regulates the air flow along the vehicle side face to thereby increase aerodynamic performance of the vehicle. Regulation of the air flow increases the volume of air that cools the braking device housed within the rim, thereby enabling an increase in the brake cooling effect.

In the vehicle wheel of the disclosure, each spoke may be curved such that an angle of inclination of the spoke increases as the spoke extends radially outward.

This configuration directs the air flow from the interior of the rim toward the rear of the vehicle and outward along the vehicle width more smoothly, to effectively regulate the air flow on the vehicle side face, thereby enabling an increase in the aerodynamic performance and brake cooling effect of the vehicle.

In the vehicle wheel of the disclosure, each spoke may include a rotationally forward face facing forward in a rotation direction of the vehicle wheel of the vehicle moving forward, a rotationally rearward face facing rearward in the rotation direction of the vehicle wheel of the vehicle moving forward, a laterally inner face facing inside of the vehicle along the vehicle width, and a laterally outer face facing outside of the vehicle along the vehicle width. Each spoke may be an elongated member having a substantially trapezoidal cross section with the laterally outer face having a shorter length than the laterally inner face. The rotationally forward face may be curved to be inclined rotationally rearward from the vehicle width direction as the rotationally forward face extends rearward along the vehicle width, and may be connected to the laterally outer face. The protrusion may extend along a direction in which each spoke extends, in a rotationally rear part of the laterally outer face.

This configuration guides the air flow from the interior of the rim toward the vehicle outside along the vehicle width, to flow from rotationally forward along the laterally outer face, and enables the air flow to be separated from the leading edge of the protrusion and generate a small vortex This small vortex prevents separation of the side flow of the vehicle from the vehicle side face at the rear of the vehicle and prevents generation of a vortex at the rear of the body, thereby increasing the aerodynamic performance of the vehicle. This configuration further increases the volume of cooling air for the braking device housed within the rim to thereby increase the brake cooling effect.

In the vehicle wheel of the disclosure, the protrusion may be disposed in a region of each spoke from a point on each spoke corresponding to a point at half a radius of the rim, toward the outer periphery of the rim.

This configuration enables an effective increase in the aerodynamic performance of the vehicle and an increase in the brake cooling effect with a simple structure.

In accordance with another aspect of the disclosure, a vehicle includes a right wheel and a left wheel. Each of the right wheel and the left wheel includes a rim having a substantially cylindrical shape, which has an outer periphery to which a tire is mounted and houses a braking device; a hub attached to an axle; and a plurality of spokes extending from the hub toward the rim to connect the hub and the rim. Each spoke is inclined circumferentially from a radial direction of the right wheel or the left wheel, and an inclining direction of the spokes of the right wheel is opposite an inclining direction of the spokes of the left wheel when viewed from respective design faces. The right wheel and the left wheel are mounted such that each of the spokes is inclined rearward in the rotation direction of the vehicle wheels of the vehicle moving forward.

Similar air flows on the right and left wheels prevent separation of the side flows on the right and left of the vehicle from the side faces of the vehicle to thereby effectively prevent generation of vortexes on the right and left at the rear of the body and increase the aerodynamic performance of the vehicle. Further, the symmetric design of the vehicle wheels on the right and left sides increases design properties of the vehicle.

The present disclosure regulates an air flow in a vehicle wheel to increase the brake cooling effect.

### BRIEF DESCRIPTION OF DRAWINGS

Embodiments of the present disclosure will be described based on the following figures, wherein:

FIG. 1 is an elevation of a vehicle wheel according to an embodiment viewed from a design face side;

FIG. 2 is a plane cross sectional view of the vehicle wheel according to the embodiment, taken along line A-A of FIG. 1;

FIG. 3 illustrates a plane cross sectional view of the vehicle wheel according to the embodiment, taken along line B-B of FIG. 1 and an enlarged cross section (details of portion C in the figure) of a spoke;

FIG. 4 is a side view illustrating a front portion of a vehicle in which a left wheel and a right wheel are mounted; and

FIG. 5 is an elevation of a vehicle wheel according to another embodiment viewed from a design face side.

### DESCRIPTION OF EMBODIMENTS

A vehicle wheel 100 according to an embodiment will be described below by reference to the drawings. In the example described below, the vehicle wheel 100 is mounted on the left side of a vehicle 50. In each drawing, arrows FR, UP, and LH respectively indicate forward, upward, and leftward of the vehicle 50 to which the vehicle wheel 100 is to be attached. Further, directions opposite the arrows FR, UP, and LH indicate rearward, downward, and rightward, respectively. In the following description, unless otherwise specified, simple reference to directions to the front and rear, right and left, and above and below indicates the front and rear along the length of the vehicle 50, the right and left along the width of the vehicle 50, and above and below along the height of the vehicle 50, respectively. Further, a face of the vehicle wheel 100 mounted on the vehicle 50, which faces outside the vehicle, will be referred to a design face 37 of the vehicle wheel 100. A side facing the design face 37 will be referred to as a design face side, and a side opposite the design face side and facing a vehicle body (not shown) of the vehicle 50 will be referred to as a vehicle body side.

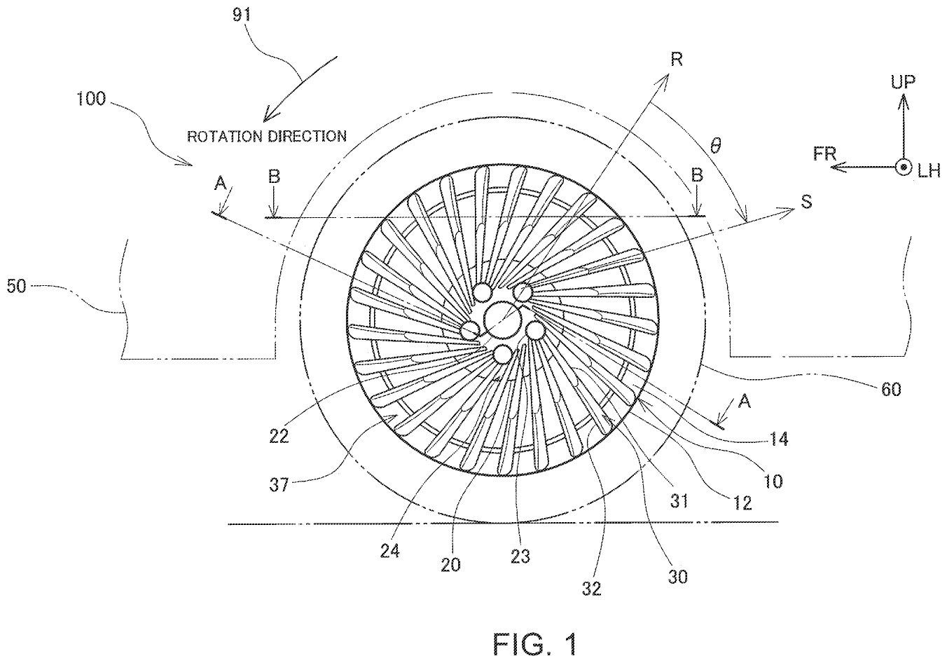

As illustrated in FIG. 1, the vehicle wheel 100 includes a rim 10, a hub 20, and spokes 30. The rim 10, the hub 20, and the spokes 30 are made of a metal such as aluminum and are integrally formed. In FIG. 1, an arrow 91 indicates a rotating direction of the vehicle wheel 100 during forward movement of the vehicle 50.

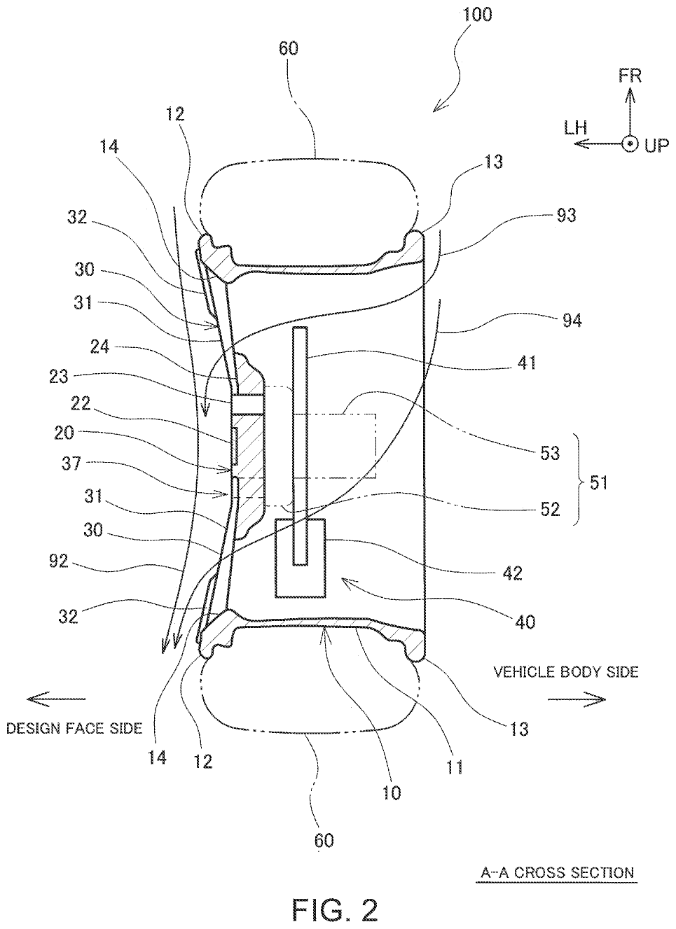

As illustrated in FIG. 2, the hub 20 is a disc-shape portion attached to an axle 51. The axle 51 of the vehicle 50 is composed of an axle hub 52 disposed at a left end of the vehicle 50 and an axle shaft 53 extending toward the vehicle body side from the axle hub 52. The axle shaft 53 is supported by a suspension that is not shown. The hub 20 includes a plurality of bolt holes 23 that allow securing bolts (not shown) mounted on the axle hub 52 to pass therethrough. The hub 20 is secured to the axle hub 52 by fastening nuts from the design face side to the securing bolts passing through the corresponding bolt holes 23 from the vehicle body side. The disc-shape hub 20 includes a circular emblem 22 in a radially center portion of the hub 20.

The rim 10 is a substantially cylindrical member disposed coaxially with the hub 20. The rim 10 includes, on opposite axial end faces on the design face side and the vehicle body side, a design face side rim flange 12 and a vehicle body side rim flange 13, respectively, each having a greater diameter than an outer perimeter 11 and protruding axially outward. A tire 60 is mounted on the outer perimeter 11 of the rim 10 between the design face side rim flange 12 and the vehicle body side rim flange 13. The rim 10 houses therein a braking device 40 including a brake disc 41 secured to the axle hub 52 to rotate with the axle hub 52 and a caliper 42 that catches the brake disc 41.

The spoke 30 is an elongated member connecting the design face side of the hub 20 and a peripheral edge 14 of the rim 10 on the design face side. The vehicle wheel 100 includes twenty-five spokes 30 disposed circumferentially at equal intervals. As illustrated in FIG. 1, each of the spokes 30 extends toward the peripheral edge 14 of the rim 10 from an outer peripheral portion 24 of the hub 20 located further radially outward relative to the radially half point of the hub 20. A direction S in which the spoke 30 extends is inclined rearward in the rotation direction of the wheel indicated by the arrow 91, by an angle θ from the radial direction R of the rim 10.

Each spoke 30 includes a body 31 extending toward the direction S, and a protrusion 32 protruding outward in the vehicle width direction or laterally from the design face 37 and extending in the direction S. The protrusion 32 is disposed in a region of the spoke 30 from a point corresponding to a point at half the radius of the rim 10 toward the outer periphery of the rim 10. The body 31 has a width, viewed from the design face side, which increases from the outer peripheral portion 24 of the hub 20 toward the peripheral edge 14 of the rim 10.

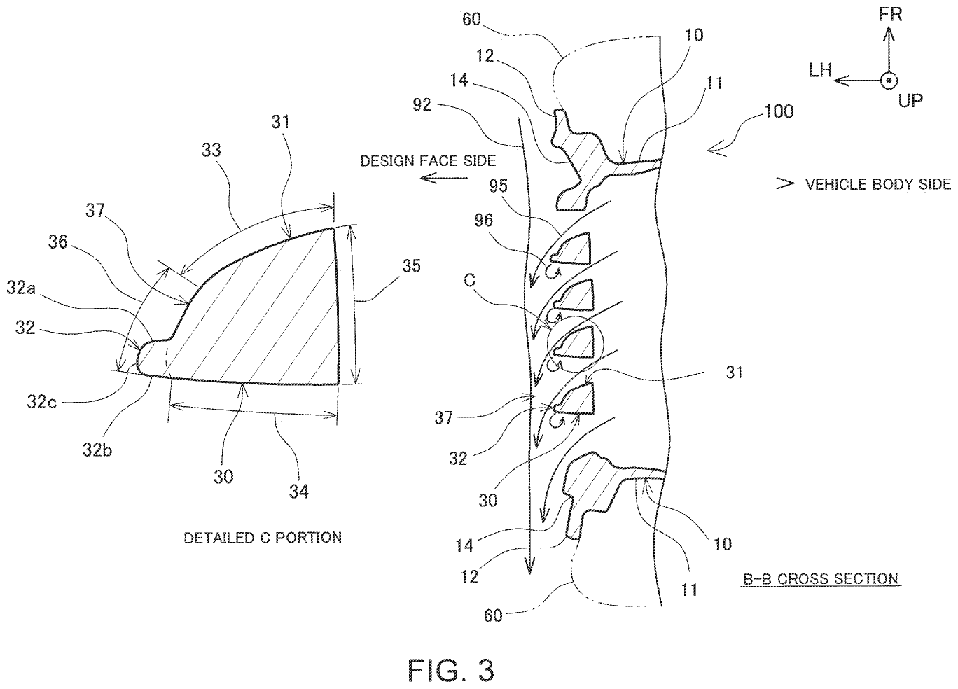

As illustrated in FIG. 3, the body 31 of the spoke 30 includes a rotationally forward face 33 facing the rotation direction of the vehicle 50 moving forward, a rotationally rearward face 34 facing opposite the rotation direction of the vehicle 50 moving forward, a laterally inner face 35 or a vehicle widthwise inner face on the vehicle body side, and a laterally outer face 36 or a vehicle widthwise outer face on the design face side. The length of the laterally outer face 36 is shorter than the length of the laterally inner face 35, and the body 31 has a substantially trapezoidal cross section having a circumferential width that decreases as the body 31 extends laterally outward. The rotationally forward face 33 is curved while being inclined rearward in the rotation direction from the lateral or vehicle width direction as the rotationally forward face 33 extends laterally outward, and is smoothly connected to the laterally outer face 36. The laterally outer face 36 forms the design face 37. Each protrusion 32 protrudes laterally outward from the laterally outer face 36 that forms the design face 37, in a rotationally rear part of the laterally outer face 36. The protrusion 32 has a rotationally rearward face 32b connected to the rotationally rearward face 34 of the body 31.

Referring to FIGS. 2 and 3, the flow of air during forward traveling of the vehicle 50 to which the vehicle wheel 100 is mounted will be described. During traveling of the vehicle 50, the air flows rearward from the front of the vehicle 50 along a side face of the vehicle 50 as indicated by an arrow 92 in FIG. 2. This air flow is referred to as a side flow. Meanwhile, the air entering through a front grille (not shown) disposed in a front portion of the vehicle 50 flows under the floor of the vehicle 50, and passes through the interior of the rim 10 from the vehicle body side and flows laterally outward through spaces among the spokes 30. The air further flows rearward of the vehicle 50 along with the side flow, as indicated by arrows 93 and 94 in FIG. 2.

As indicated by an arrow 95 in FIG. 3, the air flowing laterally outward from the interior of the rim 10 flows along the rotationally forward face 33 of the body 31 laterally outward and rearward of the vehicle. Upon hitting a rotationally forward face 32a of the protrusion 32, the air flows laterally outward along the face 32a and then separates from a tip end 32c of the protrusion 32, thereby generating a small vortex 96 at the rear of the protrusion 32 toward the rear of the vehicle. This small vortex 96 inhibits separation, from the vehicle side face, of the side flow of the vehicle 50 indicated with the arrow 92 in FIG. 3. This further inhibits generation of a vortex at the back of the body, to thereby increase the aerodynamic performance of the vehicle 50. Further, the protrusion 32 inhibits separation of the air flowing along the design face 37 of the vehicle wheel 100 from the design face 37. This enables generation of a smooth air flow from within the rim 10 toward laterally outward and thus increases the volume of cooling air for the braking device 40 housed in the rim 10, thereby increasing the brake cooling performance.

In the vehicle wheel 100 according to the embodiment, each spoke 30 extends in the direction S that is inclined rotationally rearward of the vehicle that is moving forward, by the angle θ from the radial direction R, and the rotationally forward face 33 of the body 31 of the spoke 30 is curved while being inclined rotationally rearward from the lateral direction and is smoothly connected to the laterally outer face 36. This configuration enables the air flow flowing laterally outward from the interior of the rim 10 of the vehicle wheel 100 to be guided rearward of the vehicle and laterally outward as indicated by the arrow 95 in FIG. 3, to thereby guide the air flow along the design face 37 of the vehicle wheel 100. This further prevents disturbance of the side flow along the side face of the vehicle 50 indicated by the arrow 92 in FIG. 3 and regulates the air flow on the vehicle side face, enabling an increase in the aerodynamic performance of the vehicle 50. Further, the regulated air flow increases the volume of the cooling air for the braking device 40 housed within the rim 10 to thereby enhance the brake cooling effect.

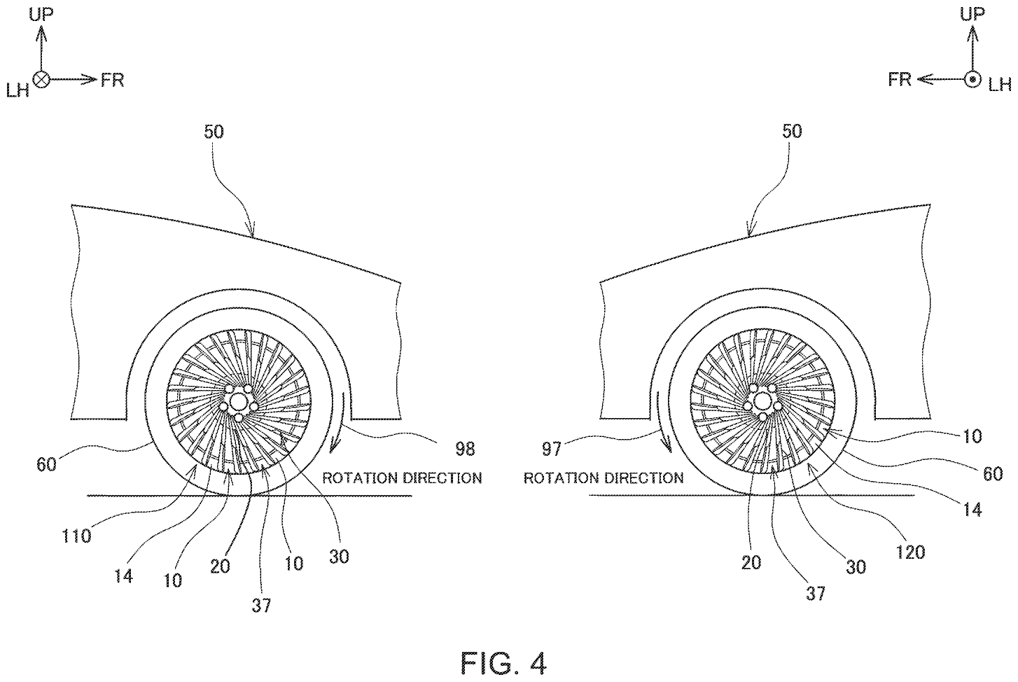

Referring now to FIG. 4, a right wheel 110 and a left wheel 120 mounted on the vehicle 50 will be described. The left wheel 120 has the same configuration as the vehicle wheel 100 described above by reference to FIGS. 1 to 3 and therefore will not be further described. As illustrated in FIG. 4, the right wheel 110 differs from the vehicle wheel 100 in that the spokes 30 of the right wheel 110 are inclined counterclockwise viewed from the design face side, which is opposite the inclination direction of the spokes 30 of the vehicle wheel 100 described above. The right wheel 110 is therefore mounted on the vehicle 50 in such a manner that each spoke 30 is inclined rearward in the rotation direction indicated by an arrow 98 in FIG. 4 during the forward movement of the vehicle 50. The remaining configuration of the right wheel 110 is the same as that of the vehicle wheel 100. The left wheel 120 is also mounted on the vehicle 50 such that each spoke 30 is inclined rearward in the rotation direction indicated by an arrow 97 in FIG. 4.

This configuration enables generation of similar air flows on the right wheel 110 and the left wheel 120 to effectively prevent generation of vortexes on the right and left sides at the rear of the body, thereby increasing the aerodynamic performance of the vehicle 50. Further, the symmetrical design of the right and left wheels increases design performance of the vehicle 50.

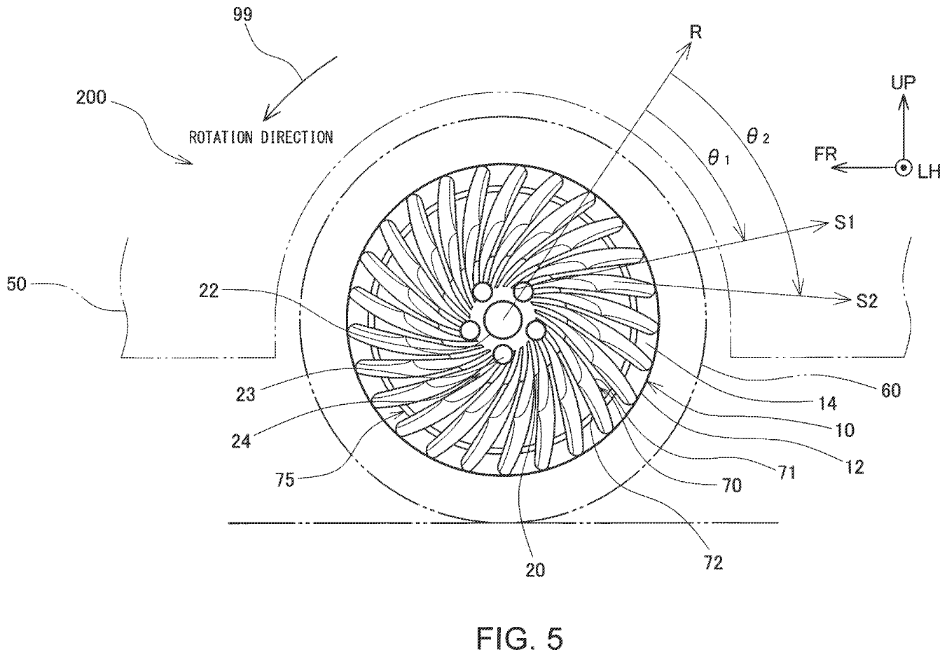

Referring to FIG. 5, a vehicle wheel 200 according to another embodiment will be described. In FIG. 5, components that are similar to those of the vehicle wheel 100 described above with reference to FIGS. 1, 2, and 3 are designated with similar reference numerals and will not be further described.

As illustrated in FIG. 5, the vehicle wheel 200 differs from the vehicle wheel 100 described above by reference to FIG. 1 to FIG. 3 in that each spoke 70 of the vehicle wheel 200 is curved such that the angle of inclination increases as the spoke 70 extends radially outward.

As illustrated in FIG. 5, in the vehicle wheel 200, the inner peripheral portion of a spoke 70 connected to the outer peripheral portion 24 of the hub 20 and which extends in a direction S1 is inclined rearward in the rotation direction indicated with an arrow 99 in FIG. 5 by an angle θ1 from the radial direction R. The outer peripheral portion of the spoke 70 connected to the peripheral edge 14 of the rim 10 and which extends in a direction S2 is inclined by an angle θ2 that is greater than the angle θ1 from the radial direction R. The spoke 70 is thus inclined in such a manner that its angle of inclination increases as the spoke 70 extends from the inner peripheral portion toward the outer peripheral portion. The spoke 70 has a body 71. A protrusion 72 is configured to extend in the extending direction of the spoke 70 along the curve 75 of the spoke 70.

The vehicle wheel 200 enables generation of a smoother air flow from the interior of the rim 10 toward the rear of the vehicle and laterally outward as compared to the vehicle wheel 100. This enables effective regulation of the air flow along the vehicle side face, thereby further increasing the aerodynamic performance and the brake cooling effect of the vehicle 50.

While in the above embodiments, each spoke 30, 70 of the vehicle wheel 100, 200 is inclined rotationally rearward of the vehicle 50 moving forward, the spoke 30, 70 may be configured to extend along the radial direction R without being inclined. This configuration slightly disturbs the air flow from the interior of the rim 10 toward the rear of the vehicle and laterally outward as compared to the configuration of the vehicle wheel 100, 200. However, small vortexes 96 (see FIG. 3) generated by each protrusion 32, 72 of the spoke 30, 70 provide a flow regulation effect to increase the aerodynamic performance and the brake cooling effect of the vehicle 50.

Further, while in the vehicle wheel 100 described above, the protrusion 32 is disposed in the region of the spoke 30 from the point of the spoke 30 corresponding to a point at half the radius of the rim 10 toward the outer periphery of the rim 10, the protrusion 32 may be longer or shorter than such a protrusion 32. For example, the protrusion 32 may extend over the entire length of the spoke 30 or may be disposed in a region of the spoke 30 from a point of the spoke 30 corresponding to a point at two-thirds of the radius of the rim 10 toward the outer periphery of the rim 10.

1. A vehicle wheel comprising:
a rim having a substantially cylindrical shape and having an outer periphery to which a tire is mounted, the rim housing a braking device;
a hub attached to an axle; and
a plurality of spokes extending from the hub toward the rim to connect the hub and the rim, wherein
each of the plurality of spokes comprises a protrusion protruding outward in a vehicle width direction from a design face of the vehicle wheel and extending along a direction in which each spoke extends.

2. The vehicle wheel according to claim 1, wherein
each of the plurality of spokes is inclined rearward in a rotation direction of the vehicle wheel of a vehicle moving forward, from a radial direction of the vehicle wheel.

3. The vehicle wheel according to claim 2, wherein
each of the plurality of spokes is curved such that an angle of inclination of the spoke increases as the spoke extends radially outward.

4. The vehicle wheel according to claim 2, wherein
each of the plurality of spokes comprises a rotationally forward face facing forward in a rotation direction of the vehicle wheel of the vehicle moving forward, a rotationally rearward face facing rearward in the rotation direction of the vehicle wheel of the vehicle moving forward, a laterally inner face facing inside of the vehicle along the vehicle width direction, and a laterally outer face facing outside of the vehicle along the vehicle width direction, each of the plurality of spokes being an elongated member having a substantially trapezoidal cross section with the laterally outer face having a shorter length than the laterally inner face,
the rotationally forward face is curved to be inclined rotationally rearward from the vehicle width direction as the rotationally forward face extends rearward along the vehicle width direction, and is connected to the laterally outer face, and
the protrusion extends along a direction in which each spoke extends, in a rotationally rear part of the laterally outer face.

5. The vehicle wheel according to claim 3, wherein
each of the plurality of spokes comprises a rotationally forward face facing forward in a rotation direction of the vehicle wheel of the vehicle moving forward, a rotationally rearward face facing rearward in the rotation direction of the vehicle wheel of the vehicle moving forward, a laterally inner face facing inside of the vehicle along the vehicle width direction, and a laterally outer face facing outside of the vehicle along the vehicle width direction, each of the plurality of spokes being an elongated member having a substantially trapezoidal cross section with the laterally outer face having a shorter length than the laterally inner face,
the rotationally forward face is curved to be inclined rotationally rearward from the vehicle width direction as the rotationally forward face extends rearward along the vehicle width direction, and is connected to the laterally outer face, and
the protrusion extends along a direction in which each spoke extends, in a rotationally rear part of the laterally outer face.

6. The vehicle wheel according to claim 4, wherein
the protrusion is disposed in a region of each spoke from a point on each spoke corresponding to a point at half a radius of the rim toward the outer periphery of the rim.

7. The vehicle wheel according to claim 5, wherein
the protrusion is disposed in a region of each spoke from a point on each spoke corresponding to a point at half a radius of the rim toward the outer periphery of the rim.

8. A vehicle comprising a right wheel and a left wheel,
each of the right wheel and the left wheel comprising:
a rim having a substantially cylindrical shape and having an outer periphery to which a tire is mounted, the rim housing a braking device;
a hub attached to an axle; and
a plurality of spokes extending from the hub toward the rim to connect the hub and the rim, wherein
each of the plurality of spokes is inclined circumferentially from a radial direction of the right wheel or the left wheel, and an inclining direction of the plurality of spokes of the right wheel is opposite an inclining direction of the plurality of spokes of the left wheel when viewed from respective design faces, and
the right wheel and the left wheel are mounted such that each of the plurality of spokes is inclined rearward in a rotation direction of the right wheel and the left wheel of the vehicle moving forward.
